(19) United States
(12) Patent Application Publication
(10) Pub. No.: US 2024/0189878 A1
(43) Pub. Date: Jun. 13, 2024

(54) WASTE LIQUID-CRYSTALLINE GLASS RECYCLING SYSTEM AND METHOD OF RECYCLING LIQUID-CRYSTALLINE GLASS

(71) Applicant: AUO Corporation, Hsin-Chu (TW)

(72) Inventors: Hsiang-Ming WANG, Hsin-Chu (TW); Pei-Yin Liu, Hsin-Chu (TW); Po-Wen Chi, Hsin-Chu (TW)

(21) Appl. No.: 18/366,974

(22) Filed: Aug. 8, 2023

(30) Foreign Application Priority Data
Dec. 8, 2022 (TW) 111147262

(51) Int. Cl. B09B 3/80; B03B 9/06; B09B 3/35; C01B 32/324

(52) U.S. Cl. CPC B09B 3/80; B03B 9/06; B09B 3/35; C01B 32/324; B09B 2101/50

(57) ABSTRACT

A waste liquid-crystalline glass recycling system includes a liquid-crystalline glass film removing module and a liquid-crystalline glass separation module connected with the liquid-crystalline glass film removing module. The liquid-crystalline glass film removing module includes a crushing device and a film removal device. The crushing device is configured to crush a liquid crystal panel. The film removal device is connected with the crushing device, and is configured to separate the liquid crystal panel into a glass-liquid crystal mixture and optical film debris. The liquid-crystalline glass separation module is connected with the liquid-crystalline glass film removing module, and is configured to separate the glass-liquid crystal mixture into glass sand and a liquid crystal mixture by using a solvent, in which the liquid crystal mixture includes the solvent.

### CROSS-REFERENCE TO RELATED APPLICATION

This application claims priority to Taiwan Application Serial Number 111147262, filed Dec. 8, 2022, which are herein incorporated by reference in its entirety.

### BACKGROUND

### Field of Invention

The present disclosure relates to a waste liquid-crystalline glass recycling system and a method of recycling liquid-crystalline glass.

### Description of Related Art

Liquid crystal panels have many usages nowadays. For example, the liquid crystal panels are commonly used for televisions, cellphones, tablets, laptops, etc. As the production of the liquid crystal panels increases year by year, the recycling method of the liquid crystal panels has also become a topic worth studying.

### SUMMARY

Some embodiments of the present disclosure provides a waste liquid-crystalline glass recycling system including a liquid-crystalline glass film removing module and a liquid-crystalline glass separation module connected with the liquid-crystalline glass film removing module. The liquid-crystalline glass film removing module includes a crushing device and a film removal device. The crushing device is configured to crush a liquid crystal panel. The film removal device is connected with the crushing device, and is configured to separate the liquid crystal panel into a glass-liquid crystal mixture and optical film debris. The liquid-crystalline glass separation module is connected with the liquid-crystalline glass film removing module, and is configured to separate the glass-liquid crystal mixture into glass sand and a liquid crystal mixture by using a solvent, in which the liquid crystal mixture includes the solvent.

In some embodiments, the crushing device includes a primary crusher, a fine crusher and a vibrating screener. The primary crusher is configured to crush the liquid crystal panel into coarse particles of liquid crystal panel debris. The fine crusher is connected with the primary crusher, and is configured to crush the coarse particles of the liquid crystal panel debris and form fine particles of the liquid crystal panel debris, in which diameters of the fine particles of the liquid crystal panel debris are smaller than diameters of the coarse particles of the liquid crystal panel debris. The vibrating screener is connected with the fine crusher, and is configured to separate the optical film debris from the fine particles of the liquid crystal panel debris.

In some embodiments, the film removal device is connected with the primary crusher, and is configured to remove first film debris of the optical film debris from the coarse particles of the liquid crystal panel debris.

In some embodiments, the film removal device is connected with the fine crusher, and is configured to remove second film debris of the optical film debris from the fine particles of the liquid crystal panel debris.

In some embodiments, the film removal device is connected with the vibrating screener, and is configured to remove third film debris of the optical film debris from the vibrating screener.

In some embodiments, the vibrating screener is connected with a mixer, and the mixer is configured to perform a wet film removal process to remove fourth film debris of the optical film debris on the fine particles of the liquid crystal panel debris, and the fine particles of the liquid crystal panel debris after performing the wet film removal process is the glass-liquid crystal mixture.

In some embodiments, the liquid-crystalline glass separation module includes a liquid storage tank and a mixer. The liquid storage tank is configured to store the solvent. The mixer is connected with the liquid storage tank, and is configured to mix the solvent and the glass-liquid crystal mixture, so that the solvent separates the glass-liquid crystal mixture into the glass sand and the liquid crystal mixture.

In some embodiments, the liquid-crystalline glass separation module further comprises a sensor and a controller. The sensor is connected with the mixer, and is configured to test a chemical property of the solvent. The controller is connected with the sensor, and is configured to receive a value of the chemical property of the solvent. A warning message is shown when the value of the chemical property is beyond a predetermined value.

In some embodiments, the liquid-crystalline glass separation module further includes an image observation box configured to observe a separation condition of the liquid crystal mixture from the mixer.

In some embodiments, the liquid-crystalline glass separation module further includes a plurality of electric control valves and a controller. The electric control valves are configured to control a flow direction of the liquid crystal mixture and the solvent. The controller is communicatively connected to the image observation box, and is configured to control the electric control valves based on an image provided by the image observation box.

In some embodiments, the waste liquid-crystalline glass recycling system further includes an optical film treatment module connected with the liquid-crystalline glass film removing module, and the optical film treatment module is configured to calcine the optical film debris.

Some embodiments of the present disclosure provide a method of recycling waste liquid-crystalline glass, including crushing a liquid-crystalline glass into a crushed mixture comprising optical film debris and a glass-liquid crystal mixture, removing the optical film debris from the crushed mixture, and after removing the optical film debris, separating the glass-liquid crystal mixture into glass sand and a liquid crystal mixture by using a solvent, in which the liquid crystal mixture includes the solvent.

In some embodiments, separating the glass-liquid crystal mixture into the glass sand and the liquid crystal mixture by using the solvent includes mixing the solvent and the glass-liquid crystal mixture by a mixer, observing the glass-liquid crystal mixture from the mixer, and controlling a flow direction of the liquid crystal mixture by a plurality of electric control valves based on a separation condition of the liquid crystal mixture.

In some embodiments, the method includes testing chemical properties of the solvent in the mixer by a sensor, determining whether the solvent should be renewed based on the chemical properties of the solvent.

In some embodiments, observing the glass-liquid crystal mixture from the mixer includes transporting the liquid crystal mixture to a settling tank, separating the liquid crystal mixture in the settling tank, capturing the separation condition of the liquid crystal mixture as an image, and returning the image to the controller.

In some embodiments, the method further includes determining whether the liquid crystal mixture in the mixer is well-stratified into a liquid crystal and the solvent by the controller based on the image returned to the controller before controlling the flow direction of the liquid crystal mixture by the electric control valves.

In some embodiments, the solvent is a mixture of sweet orange oil and polyethylene glycol, and total organic carbon of the solvent is between 24000 ppm to 100000 ppm.

In some embodiments, the method further includes calcining the optical film debris to form active carbon after removing the optical film debris.

In some embodiments, crushing the liquid-crystalline glass into a crushed mixture includes performing a primary crushing process of the waste liquid-crystalline glass to form coarse particles of the liquid-crystalline glass, and crushing the coarse particles of the liquid-crystalline glass to form fine particles of liquid-crystalline glass.

In some embodiments, removing the optical film debris from the crushed mixture includes removing first film debris of the optical film debris from the coarse particles of the liquid-crystalline glass, removing second film debris of the optical film debris from the fine particles of the liquid-crystalline glass, transporting the fine particles of the liquid-crystalline glass to the vibrating screener, separating the optical film debris from the fine particles of the liquid-crystalline glass to remove third film debris of the optical film debris from the vibrating screener, and performing a wet film removal process to remove fourth film debris of the optical film debris on the fine particles of the liquid-crystalline glass.

As mentioned above, in some embodiments of the present disclosure, optical film, glass and liquid crystal are respectively separated from the waste liquid crystal panel. The optical film, glass and liquid crystal are respectively reutilized, so that the optical film, glass and liquid crystal may be available for other purposes, thereby reducing waste generation.

It is to be understood that both the foregoing general description and the following detailed description are by examples, and are intended to provide further explanation of the invention as claimed. It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiment, with reference made to the accompanying drawings as follows:

FIG. 1 illustrates a block diagram of a waste liquid-crystalline glass recycling system in some embodiments of the present disclosure.

FIG. 2 illustrates a flow chart of using the waste liquid-crystalline glass recycling system to recycle glass, optical film, and liquid crystal in some embodiments of the present disclosure.

FIG. 3 illustrates an equipment diagram of the liquid-crystalline glass film removing module and the liquid-crystalline glass separation module in FIG. 1.

FIG. 4 illustrates a diagram of a portion of the crushing device in FIG. 3.

FIG. 5 illustrates an equipment diagram of the other portion of the crushing device in FIG. 3.

FIG. 6 illustrates an equipment diagram of the film removal device in FIG. 3.

FIG. 7 illustrates an equipment diagram of the mixer in FIG. 3.

FIG. 8 illustrates detailed operations in step S110 and step S120 in FIG. 2.

FIG. 9 illustrates an equipment diagram of the glass storage area in FIG. 3.

FIG. 10 illustrates the detailed operations of step S130 in FIG. 2.

FIG. 11 illustrates the changes in chemical properties measured after extraction of different batches of glass-liquid crystal mixture with the same solvent in a laboratory in some embodiments.

FIG. 12 illustrates a GC spectrum of the liquid crystal mixture in some embodiments.

### DETAILED DESCRIPTION

The following disclosure provides many different embodiments, or examples, for implementing different features of the invention. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “underlying,” “below,” “lower,” “overlying,” “upper” and the like, may be used herein for ease of description to describe one element or feature's relationship to another element(s) or feature(s) as illustrated in the figs. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

Some embodiments of the present disclosure are related to a method of recycling glass in the liquid crystal panel. Specifically, in some embodiments of the present disclosure, optical film, glass and liquid crystal are respectively separated from the waste liquid crystal panel. The optical film, glass and liquid crystal are respectively recycled and utilized, so that the optical film, glass and liquid crystal may be available for other purposes, thereby reducing waste generation.

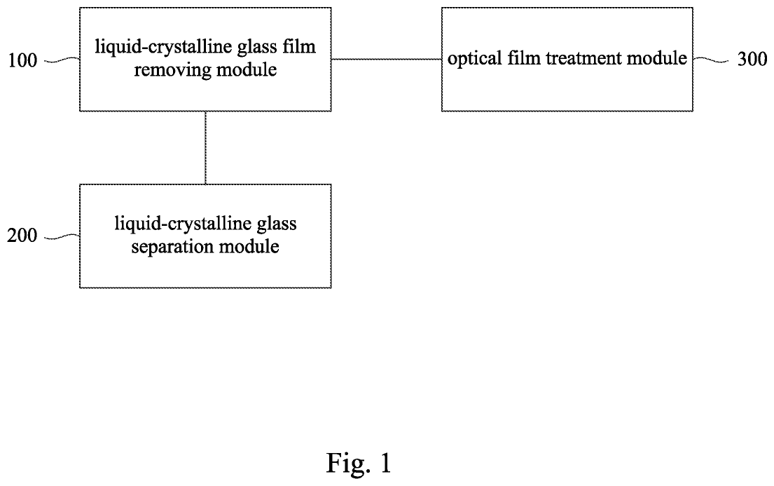

FIG. 1 illustrates a block diagram of a waste liquid-crystalline glass recycling system in some embodiments of the present disclosure. The source of the waste liquid-crystalline glass recycling system may be waste liquid crystal panel, and the liquid crystal panel may include optical film, glass and liquid crystal. The waste liquid-crystalline glass recycling system may include a liquid-crystalline glass film removing module 100, a liquid-crystalline glass separation module 200 and an optical film treatment module 300. The liquid-crystalline glass film removing module 100 may separate the liquid crystal panel into a glass-liquid crystal mixture and optical film debris. The liquid-crystalline glass separation module 200 is connected with the liquid-crystalline glass film removing module 100, and is configured to configured to separate the glass-liquid crystal mixture into glass sand and a liquid crystal mixture. The optical film treatment module 300 is connected with the liquid-crystalline glass film removing module 100 and is configured to calcine the optical film debris.

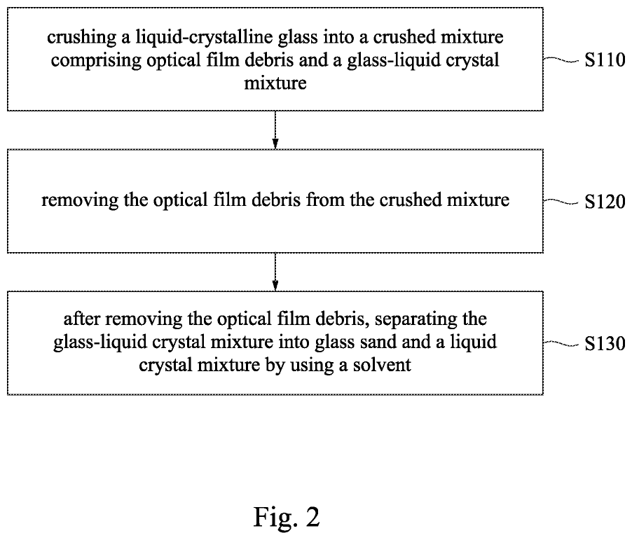

FIG. 2 illustrates a flow chart of using the waste liquid-crystalline glass recycling system to recycle glass, optical film, and liquid crystal in some embodiments. Specifically, firstly, in step S110, a liquid-crystalline glass is crushed into a crushed mixture including optical film debris and a glass-liquid crystal mixture. Subsequently, in step S120, the optical film debris is removed from the crushed mixture. Subsequently, in step S130, after removing the optical film debris, the glass-liquid crystal mixture is separated into glass sand and a liquid crystal mixture by using a solvent, and the liquid crystal mixture includes the solvent. As such, waste liquid-crystalline glass may be separated into the optical film, the glass and the liquid crystal. The optical film, the glass and the liquid crystal are respectively recycled and utilized to reduce waste generation. Details related to steps S110-S130 may be discussed later.

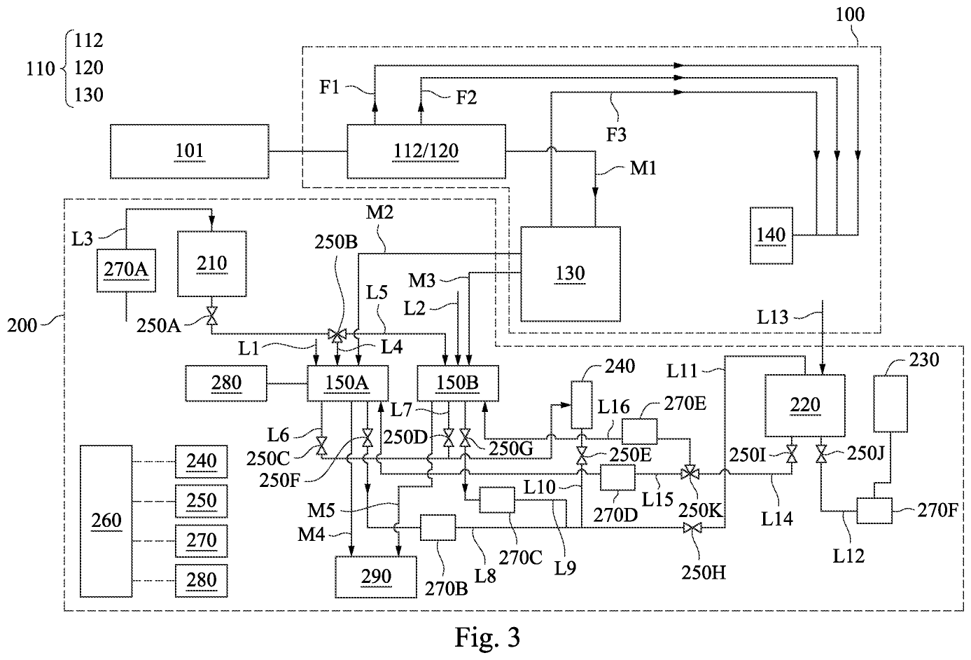

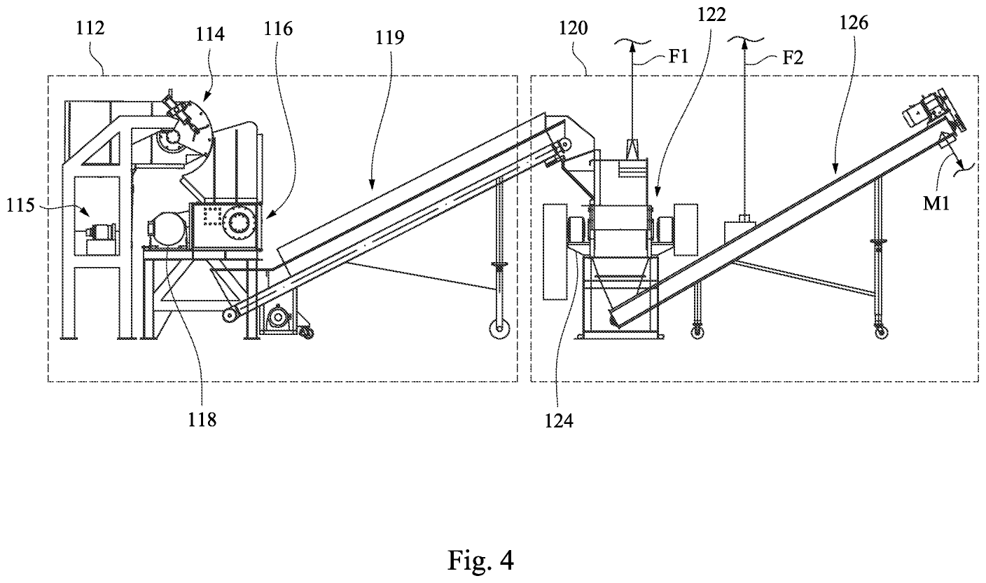

FIG. 3 illustrates an equipment diagram of the liquid-crystalline glass film removing module 100 and the liquid-crystalline glass separation module 200 in FIG. 1. The liquid-crystalline glass film removing module 100 includes a crushing device 110 and a film removal device 140. The crushing device 110 is configured to crush a liquid crystal panel. The crushing device 110 includes a primary crusher 112, a fine crusher 120 and a vibrating screener 130. FIG. 4 illustrates a diagram of a portion of the crushing device 110 in FIG. 3. Referring to FIGS. 3 and 4, a primary crusher 112 is configured to crush the liquid crystal panel into coarse particles of liquid crystal panel debris. The liquid crystal panel may be transported to a feeding turnover device 114 from a stacker 101 in FIG. 3. The feeding turnover device 114 may be driven by a motor 115. The feeding turnover device 114 may be connected with a rotating device 116, so that the liquid crystal panel may enter the rotating device 116 and be crushed. The rotating device 116 may include multiple cutters and blades, and the cutters and blades may be driven by the motor 118 to crush the liquid crystal panel into the coarse particles of liquid crystal panel debris. The coarse particles of liquid crystal panel debris crushed in the rotating device 116 may be transported to the fine crusher 120 by the conveyor 119 to perform the next step of glass crushing operation.

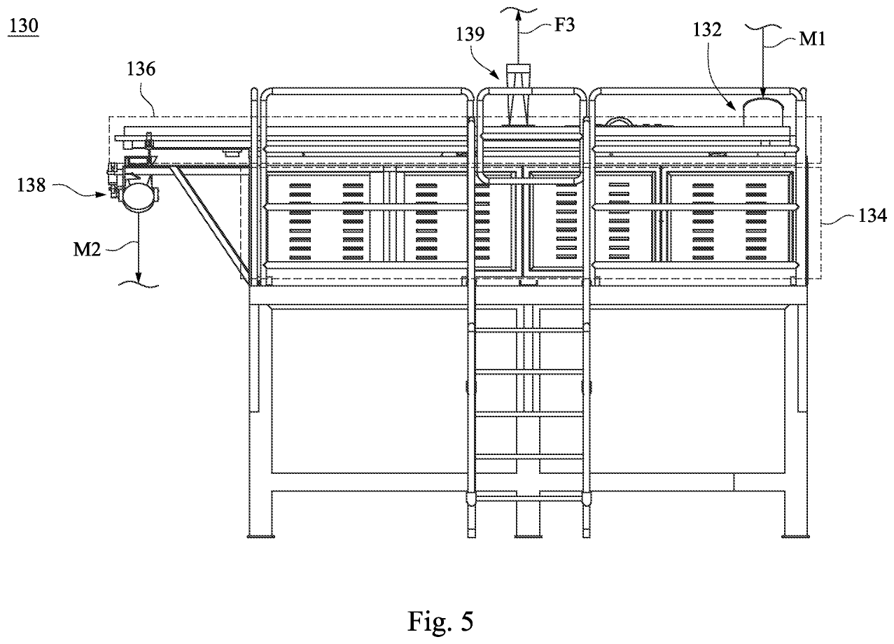

The fine crusher 120 is connected with the primary crusher 112, and is configured to crush the coarse particles of the liquid crystal panel debris and form fine particles of the liquid crystal panel debris, in which diameters of the fine particles of the liquid crystal panel debris are smaller than diameters of the coarse particles of the liquid crystal panel debris. The fine crusher 120 includes a rotating device 122, a motor 124 and a conveyor 126. The rotating device 122 may include multiple cutters and blades, and the cutters and blades may be driven by the motor 124 to crush the coarse particles of liquid crystal panel debris into the fine particles of the liquid crystal panel debris. The conveyor 126 may transport the fine particles of the liquid crystal panel debris to the next equipment (such as vibrating screener 130 in FIGS. 3 and 5), and is illustrated as material flow M1 in FIGS. 3 and 4. In present disclosure, material flow M1 and material flow M2-M5 in later discussion mean that the transported materials are not transported through the pipeline in FIG. 3. For example, the outlet of the conveyor 126 of the fine crusher 120 may be directly above the inlet of the vibrating screener 130 to directly transport the fine particles of the liquid crystal panel debris to the vibrating screener 130. The fine crusher 120 may be connected with film collection pipes F1 and F2 to collecting the optical film debris generated by crushing the coarse particles of liquid crystal panel debris to the film removal device 140 (FIG. 3). In some embodiments, the film collection pipe F1 is connected with the area of the fine crusher 120 where the fine crushing has not yet been performed, so the film collection pipe F1 may be used to collect the optical film debris in the coarse particles of liquid crystal panel debris. The film collection pipe F2 is connected with the area of the fine crusher 120 where the fine crushing has been performed, so the film collection pipe F2 may be used to collect the optical film debris in the fine particles of liquid crystal panel debris.

FIG. 5 illustrates an equipment diagram of the other portion of the crushing device 110 in FIG. 3. Referring to FIGS. 3 and 5, the vibrating screener 130 is connected with the fine crusher 120, and is configured to separate the optical film debris from the fine particles of the liquid crystal panel debris. The vibrating screener 130 includes an inlet 132, a separation area 134, a transportation area 136, a film collecting outlet 138 and a material outlet 139. The inlet 132 is configured to receive the fine particles of the liquid crystal panel debris in material flow M1 from the fine crusher 120. The separation area 134 is configured to separate the optical film debris from the fine particles of the liquid crystal panel debris. In some embodiments, several springs are configured in the separation area 134, so the materials with different specific gravity (such as glass and optical film) in the separation area 134 may be separated by vibrating. The separated optical film debris may be collected to the film removal device 140 by the film collecting outlet 138 and a film collection pipe F3. The remaining fine particles of the liquid crystal panel debris are transported to the next equipment (such as mixer 150A or 150B) by the material outlet 139 and material flow M2 (or material flow M3 in FIG. 3).

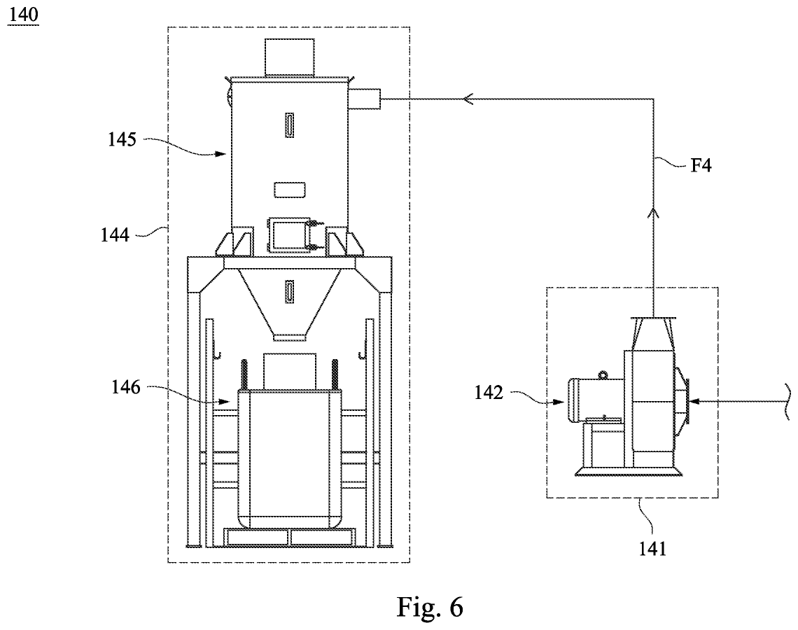

FIG. 6 illustrates an equipment diagram of the film removal device 140 in FIG. 3. Referring to FIGS. 3 and 6, the film removal device 140 is connected with the crushing device 110, and is configured to separate the liquid crystal panel into a glass-liquid crystal mixture and optical film debris. The film removal device 140 is connected with the primary crusher 112, and is configured to remove first film debris of the optical film debris from the coarse particles of the liquid crystal panel debris. The film removal device 140 is further connected with the fine crusher 120, and is configured to remove second film debris of the optical film debris from the fine particles of the liquid crystal panel debris. The film removal device 140 is further connected with the vibrating screener 130, and is configured to remove third film debris of the optical film debris from the vibrating screener 130. The “first film debris”, “second film debris”, and “third film debris” represent the optical film debris separated at different stages respectively. Specifically, the film removal device 140 may include an exhaust fan 141 and a vacuum equipment 144. The exhaust fan 141 may include a motor 142. The exhaust fan 141 may be driven by the motor 142 to transport the optical film debris to the vacuum equipment 144 by the film collection pipes F1, F2, F3 and F4. The vacuum equipment 144 may include a cyclone separator 145 and a weighbridge 146. The cyclone separator 145 can make the optical film debris in the cyclone separator 145 collide with the wall of the cyclone separator 145 and fall into the weighbridge 146 by centrifugal force. The weighbridge 146 collects and measures the weight of the separated optical film debris.

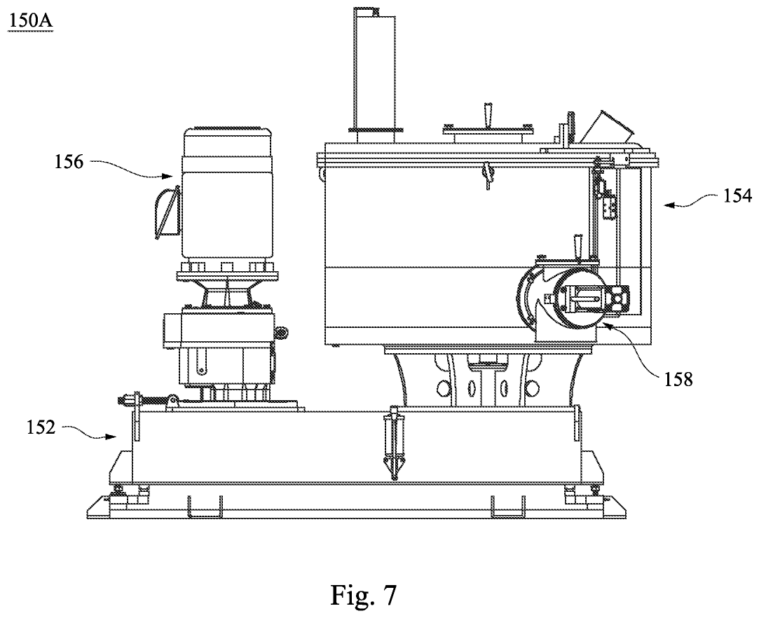

In the present disclosure, the vibrating screener 130 is further connected with the mixers 150A and 150B. FIG. 7 illustrates an equipment diagram of the mixer 150A in FIG. 3. Specifically, the mixer 150A includes a platform 152, a tank 154, and a motor 156. The platform 152 may be used to dispose the tank 154 and the motor 156, and the platform 152 includes a scale used to measure the weight of the material in the mixer 150A. The tank 154 includes suitable blades, and the motor 156 is configured to drive the blades in the tank 154 to mix the liquid and the glass in the tank 154. The mixer 150A further includes a glass outlet valve 158, which is configured to transport the glass in the tank 154 to a glass storage area 290. The glass outlet valve 158 is an electric control valve, and is controlled by a dry air pipeline on the tank 154. The structure of the mixer 150B is similar to or the same as the structure of the mixer 150A, and is not repeatedly described herein.

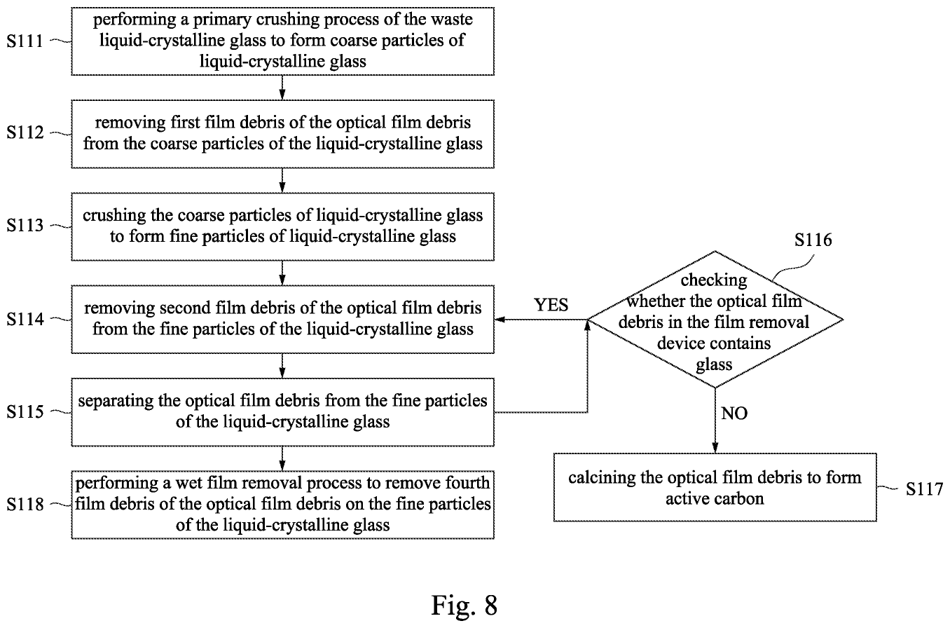

FIG. 8 illustrates detailed operations in step S110 and step S120 in FIG. 2. In step S111, a primary crushing process of the waste liquid-crystalline glass to form the coarse particles of liquid crystal panel debris. Specifically, waste liquid-crystalline glass may enter the primary crusher 112 from the stacker 101. The waste liquid-crystalline glass entering the primary crusher 112 from the stacker 101 is the liquid-crystalline glass containing optical films, such as waste liquid crystal panels. During performing the primary crushing process of the waste liquid-crystalline glass, a portion of the optical films on the waste liquid-crystalline glass falls off the waste liquid-crystalline glass, to form first film debris of the optical film debris. Therefore, after step S111, the coarse particles of liquid crystal panel debris and the first film debris of the optical film debris are obtained. In some embodiments, the size (such as width) of the coarse particles of liquid crystal panel debris and the first film debris of the optical film debris is in a range about 5 cm to 20 cm.

Subsequently, in step S112, the first film debris of the optical film debris is removed from the coarse particles of liquid crystal panel debris. After performing the primary crushing process of the waste liquid-crystalline glass, the first film debris of the optical film debris is sucked into the film removal device 140 through the film collection pipe F1. In some embodiments, about 50 wt % to 55 wt % of the optical film debris is removed in the step S112. That is, the first film debris accounts for about 50 wt % to 55 wt % of the optical film debris.

Subsequently, in step S113, the coarse particles of liquid crystal panel debris are crushed to form fine particles of liquid crystal panel debris. Specifically, the step S113 is performed in the fine crusher 120, and the coarse particles of liquid crystal panel debris are crushed into the fine particles of liquid crystal panel debris by hob crushing. The remaining portion of the optical films on the waste liquid-crystalline glass falls off the waste liquid-crystalline glass. The diameter of the fine particles of the liquid crystal panel debris is smaller than the diameter of the coarse particles of liquid crystal panel debris. In some embodiments, the diameter of the fine particles of the liquid crystal panel debris and the optical film debris in the fine crusher 120 is less than about 2 mm.

Subsequently, in step S114, the second film debris of the optical film debris is removed from the fine particles of liquid crystal panel debris. Specifically, after crushing the coarse particles of liquid crystal panel debris, a portion of the optical film debris, i.e. second film debris, is sucked into the film removal device 140 through the film collection pipe F2. The second film debris is the portion of the optical film debris that is not pinned by the fine particles of liquid crystal panel debris, so the second film debris can be easily removed by the film removal device 140. The other portion of the optical film debris is still pinned by the fine particles of liquid crystal panel debris, so it cannot be directly removed in the fine crusher 120 by the film removal device 140.

Subsequently, in step S115, the optical film debris is separated from the fine particles of the liquid crystal panel debris to remove the third film debris of the optical film debris from the vibrating screener 130. The fine particles of the liquid crystal panel debris may be transported to the vibrating screener 130 through the material flow M1. The vibrating screener 130 may be used to separate the fine particles of the liquid crystal panel debris with high specific gravity and the optical film debris with low specific gravity by vibrating. The optical film debris with low specific gravity serves as the third film debris of the optical film debris, and is transported to the film removal device 140 through the film collection pipe F3. In some embodiments, after step S115, more than 90 wt % of the optical film debris may be removed. That is, the first film debris, the second film debris and the third film debris accounts for more than 90 wt % of the optical film debris. In some embodiments, the efficiency of removing the first film debris, the second film debris and the third film debris may be up to 99%. Separating the fine particles of the liquid crystal panel debris and the optical film debris by using the vibrating screener 130 may has the advantages of small equipment footprint and low operating cost.

In steps S112, S114 and S115, the first film debris, the second film debris and the third film debris of the optical film debris are all collected to the film removal device 140. Subsequently, in step S116, check whether the optical film debris in the film removal device 140 contains glass. If the optical film debris in the film removal device 140 contains glass, the optical film debris in the film removal device 140 is transported back to the fine crusher 120 and steps S114-S116 are repeated until the optical film debris in the film removal device 140 does not contain glass. If the optical film debris in the film removal device 140 does not contain glass, then step S117 is performed to calcine the optical film debris to form active carbon.

In step S117, specifically, the optical film debris in the film removal device 140 is transported to the optical film treatment module 300 (See FIG. 1). In some embodiments, the optical film treatment module 300 (See FIG. 1) may be an activation furnace to calcine the optical film debris to form active carbon. In some embodiments, the optical film debris may be calcined at 600 degree Celsius to 800 degree Celsius in vacuum or hypoxic environment. In some embodiments, the conversion of calcining the optical film debris to form active carbon is about 40%, and the active carbon after calcination may be made into any suitable shape, such as powder or particles. The active carbon after calcination has many usages. For example, active carbon may be used in air pollution equipment to adsorb pollutants. As such, the optical film in the waste liquid-crystalline glass is reused and forms valuable active carbon, thereby reducing the generation of the waste optical film.

After separating the optical film debris from the fine particles of the liquid crystal panel debris in step S115, the fine particles of the liquid crystal panel debris are transported to the mixers 150A and 150B. Subsequently, in step S118, a wet film removal process is performed to remove the fourth film debris of the optical film debris on the fine particles of the liquid-crystalline glass, so that it is ensured that there is no optical film debris in the fine particles of the liquid crystal panel debris. The fine particles of the liquid crystal panel debris after performing the wet film removal process are a glass-liquid crystal mixture. That is, after performing the wet film removal process, the fine particles of the liquid crystal panel debris does not contains the optical film debris substantially. During the wet film removal process, firstly, water is introduced to the mixers 150A and 150B containing the fine particles of the liquid crystal panel debris through pipelines L1 and L2 respectively. The liquid-crystalline glass debris and the fourth film debris of the optical film debris in the fine particles of the liquid crystal panel debris have different buoyancy in water, so the fourth film debris of the optical film debris is discharged from the mixers 150A and 150B when discharging water from the mixers 150A and 150B. Therefore, the fine particles of the liquid crystal panel debris do not contain optical film debris substantially, and the fine particles of the liquid crystal panel debris are the glass-liquid crystal mixture. The glass-liquid crystal mixture proceeds to the next step. In some embodiments, the efficiency of removing the fourth film debris may be up to 99%-100%.

Back to FIG. 3, the liquid-crystalline glass separation module 200 includes a liquid storage tank 210, the mixers 150A and 150B, a settling tank 220, a liquid crystal storage tank 230, an image observation box 240, electric control valves 250, a controller 260, pumps 270, sensors 280 and a glass storage area 290.

The liquid storage tank 210 is configured to store a solvent. The solvent is a mixture of sweet orange oil (C₁₀H₁₆) and polyethylene glycol (PEG), and total organic carbon (TOC) of the solvent is between 24000 ppm to 100000 ppm. The solvent may be used to extract liquid crystal from the glass-liquid crystal mixture to the solvent.

The mixers 150A and 150B are connected with the liquid storage tank 210, and are configured to mix the solvent and the glass-liquid crystal mixture, so that the solvent separates the glass-liquid crystal mixture into the glass sand and the liquid crystal mixture. The liquid crystal mixture includes the liquid crystal and the solvent. In the mixers 150A and 150B, the solvent extracts the liquid crystal from the glass-liquid crystal mixture to the solvent. The mixers 150A and 150B may be the equipment used for wet film removal process at the same time. That is, both the wet film removal process and the operation of mixing the solvent and the glass-liquid crystal mixture are performed in the mixers 150A and 150B. It is noted that, although two mixers 150A and 150B are illustrated in FIG. 3, the number of the mixers is not limited to 2. For example, the number of the mixers may be 3 or more. In some embodiments, the mixers 150A and 150B may be used to perform extraction of the liquid crystal at the same time or different time. Alternately, the extraction of the liquid crystal in the mixers 150A and 150B may not start at the same time. The present disclosure is not limited thereto. In some other embodiments, one of the mixers 150A and 150B (such as mixer 150A) is used to perform the wet film removal process. After the wet film removal process performed in the mixer is complete, the glass-liquid crystal mixture is transported to the other one of the mixers 150A and 150B (such as mixer 150B) to perform the next step. In this embodiment, one of the mixers 150A and 150B may be used to perform the wet film removal process, and the other one of the mixers 150A and 150B may be used to perform the extraction of the liquid crystal. That is, in some embodiments, the liquid-crystalline glass film removing module 100 may include the mixer 150A, and the liquid-crystalline glass separation module 200 may include the mixer 150B. The mixers 150A and 150B may be shown in FIG. 7.

The settling tank 220 is connected with the mixers 150A and 150B, and is configured to store the liquid crystal mixture from the mixers 150A and 150B, and the liquid crystal and the solvent in the liquid crystal mixture may be separated by the difference in specific gravity. That is, the liquid crystal mixture may be separated into the liquid crystal and the solvent in the settling tank 220. The liquid crystal storage tank 230 is connected with the settling tank 220, and is configured to store the liquid crystal separated from the settling tank 220.

The image observation box 240 is configured to observe the separation condition of the liquid crystal mixture from mixers 150A and 150B. The image observation box 240 is connected with the mixers 150A and 150B. The image observation box 240 is a small settling tank. Therefore, the liquid crystal mixture is separated in the image observation box 240, so that obvious stratification is formed between the liquid crystal and the solvent in the liquid crystal mixture. Since the image observation box 240 only contains a small amount of the liquid crystal mixture, the liquid crystal mixture in the image observation box 240 is stratified more rapidly. The image observation box 240 is equipped with a camera, and the camera is configured to observe the separation condition of the liquid crystal mixture.

In some embodiments, the settling tank 220 is also equipped with an image observation box, and the image observation box is configured to observe the separation condition of the liquid crystal mixture in the settling tank 220. The image observation box is also equipped with a camera, and the camera is configured to observe the separation condition of the liquid crystal mixture.

The electric control valves 250 are configured to control a flow direction of the liquid crystal mixture and the solvent. Specifically, the electric control valves 250 may be disposed at the pipelines among the equipment in the liquid-crystalline glass separation module 200. The controller 260 is communicatively connected to the image observation box 240, and is configured to control the electric control valves 250 based on an image provided by the image observation box 240. The electric control valves 250 may include electric control valves 250A-250K, and the detailed usage of the electric control valves 250A-250K will be described in later discussion. The pumps 270 are configured to transport the liquid in the pipelines to certain location or certain piece of the equipment. The pumps 270 may include pumps 270A-270F. The controller 260 may be used to control the pumps 270 based on the image, and the detailed usage of the pumps 270A-270F will be described in later discussion.

The sensors 280 are configured to test chemical properties of the solvent. In some embodiments, the sensors 280 may be used to test oxidation reduction potential (ORP), turbidity and other chemical properties. The controller 260 is further connected with the sensors 280, and is configured to receive values of the chemical properties of the solvent and show a warning message when some of the values of the chemical properties are beyond predetermined values. In some embodiments, the sensors 280 may be disposed in the mixers 150A and 150B.

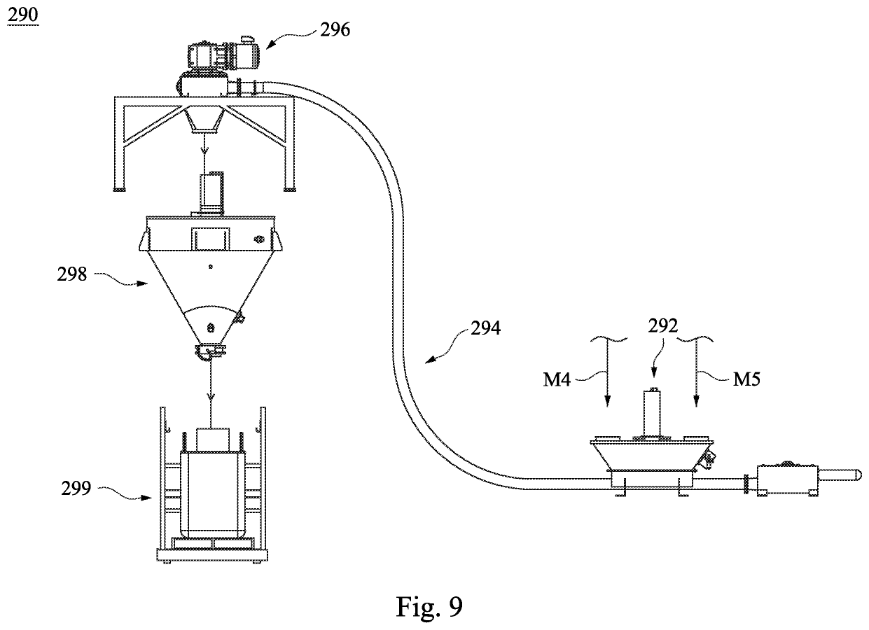

The glass storage area 290 is configured to receive and collect glass sand from the mixers 150A and 150B. FIG. 9 illustrates an equipment diagram of the glass storage area 290 in FIG. 3. Referring to FIGS. 3 and 9, specifically, the glass storage area 290 includes a delivery vehicle 292, chain pipes 294, a motor 296, a temporary storage tank 298 and a weighbridge 299. The delivery vehicle 292 is configured to receive sand glass from which liquid crystals have been removed from the mixers 150A and 150B through material flow M4 and M5. The temporary storage tank 298 is configured to store the glass sand transported by the delivery vehicle 292 temporarily. The chain pipes 294 are configured to provide a path for the delivery vehicle 292 to transport the glass sand from the mixers 150A and 150B to the temporary storage tank 298, and the motor 296 may be used to drive the chain pipes 294 and make the delivery vehicle 292 move. When the sand glass is accumulated in the temporary storage tank 298 to a certain level, the outlet at the bottom of the temporary storage tank 298 is opened, so that the weighbridge 299 below receives the glass sand from the temporary storage tank 298. The weighbridge 299 may also be used to measure the weight of the collected glass sand.

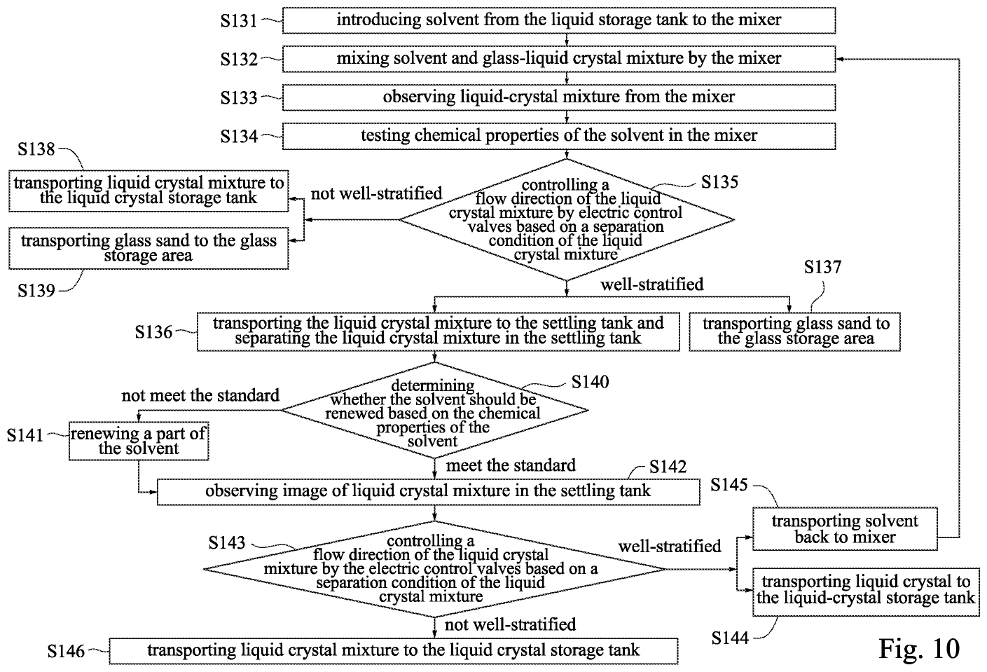

The operations of the equipment in the liquid-crystalline glass separation module 200 are discussed in details in FIG. 10. FIG. 10 illustrates the detailed operations of step S130 in FIG. 2. Referring to FIGS. 10 and 3, in step S131, the solvent is introduced from the liquid storage tank 210 to the mixers 150A and 150B. Specifically, after the wet film removal process is done in the mixers 150A and 150B, the optical film debris in the fine particles of the liquid crystal panel debris is removed. The remaining glass-liquid crystal mixture remains in the mixers 150A and 150B, and the solvent is introduced to the mixers 150A and 150B respectively through the electric control valves 250A, 250B and pipelines L4, L5. As such, the mixers 150A and 150B accommodate the glass-liquid crystal mixture and the solvent at the same time. In some embodiments, the pipelines L4 and L5 may transport the solvent to the mixers 150A and 150B at the same time or different time. In some embodiments, the solvent may be transported through a pipeline L3 and the pump 270A to the liquid storage tank 210 in advance. In some other embodiments, one of the mixers 150A and 150B may accommodate the glass-liquid crystal mixture and the solvent to perform subsequent operation (such as step S132). The other mixers 150A and 150B may be used to perform the wet film removal process.

Subsequently, in step S132, the solvent and the glass-liquid crystal mixture are mixed by the mixers 150A and 150B, to extract the liquid crystal in the glass-liquid crystal mixture into the solvent. In some embodiments, the extraction may be performed at the temperature in a range from 5 degree Celsius to 45 degree Celsius, with duration in a range from 10 minutes to 30 minutes, and at rotating speed in a range from 10 rpm to 100 rpm. It is hard to damage the liquid crystal in the glass-liquid crystal mixture when performing the extraction under the working condition mentioned above, so the liquid crystal may be utilized subsequently. When the extraction is finished, the liquid crystal in the glass-liquid crystal mixture may be extracted into the solvent. Therefore, the solvent and the glass-liquid crystal mixture may be separated in to the glass sand and the liquid crystal mixture, and the liquid crystal mixture includes the solvent and the liquid crystal separated from the glass-liquid crystal mixture. After step S132 is finished, the glass sand is at the bottom of the mixers 150A and 150B, and the liquid crystal mixture is above the glass sand.

Subsequently, in step S133, the separation condition of the liquid crystal mixture from the mixers 150A and 150B is observed by the image observation box 240. Specifically, the electric control valves 250C and 250D may be opened, and a small amount of the liquid crystal mixture may be transported to the image observation box 240 through pipelines L6 or L7 respectively. The image observation box 240 is a small settling tank. Therefore, the liquid crystal mixture is separated in the image observation box 240, so that obvious stratification is formed between the liquid crystal and the solvent in the liquid crystal mixture. Since the image observation box 240 only contains a small amount of the liquid crystal mixture, the liquid crystal mixture in the image observation box 240 is stratified more rapidly. The image observation box 240 is equipped with the camera, which is configured to observe the separation condition of the liquid crystal mixture. The separation condition of the liquid crystal mixture is captured as image and is returned to the controller 260.

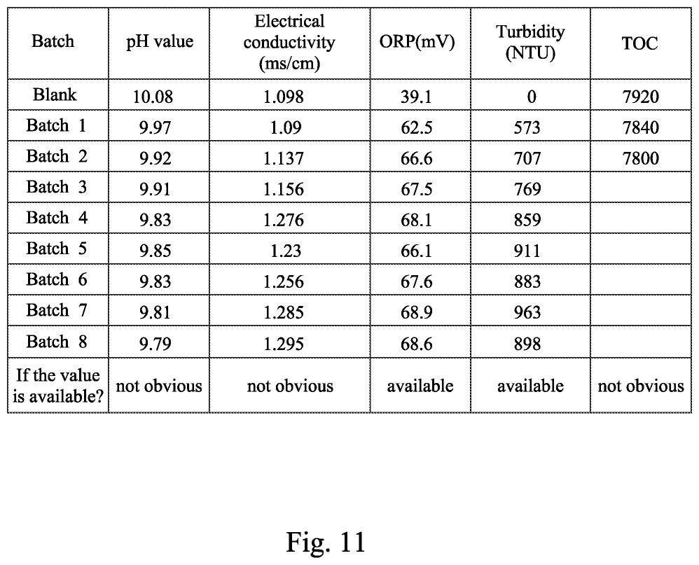

Subsequently, in step S134, the chemical properties of the solvent in the mixers 150A and 150B are tested. Specifically, since the solvent in some embodiments of the present disclosure are reusable to separate different batches of the glass-liquid crystal mixture, whether the solvent is suitable for separating glass-liquid crystal mixture may be determined by testing the chemical properties of the solvent. FIG. 11 illustrates the changes in chemical properties measured after extraction of different batches of glass-liquid crystal mixture with the same solvent in a laboratory in some embodiments. FIG. 11 illustrates numerical changes in pH value, electric conductivity, oxidation reduction potential (ORP), turbidity, total organic carbon of the solvent after extraction of different batches of glass-liquid crystal mixture. According to FIG. 11, compared to the blank reagent (including 10 wt % solvent and 90 wt % water), the changes in ORP and turbidity are more obvious, so ORP and turbidity are suitable for determining whether the solvent is suitable for separating the glass-liquid crystal mixture. In some embodiments, it is effective to separate the liquid crystal from the glass-liquid crystal mixture by using the solvent when the ORP of the solvent is in a range from 40 mV to 70 mV and the turbidity of the solvent is in a range from 0 to 950 NTU. If the ORP or the turbidity of the solvent is not within the disclosed range, it means that the solvent contains too much liquid crystal. The liquid crystal may not be separated from the glass-liquid crystal mixture effectively, and the solvent may be renewed in the subsequent step to maintain the quality of the solvent. The chemical properties of the solvent may be tested by the sensor 280 in the mixers 150A and 150B. In some embodiments, steps S133 and S134 are performed at the same time.

Subsequently, in step S135, a flow direction of the liquid crystal mixture is controlled by the electric control valves 250 based on the separation condition of the liquid crystal mixture in step S133. Specifically, the controller 260 may determine whether the liquid crystal mixture is well-stratified in the image observation box 240 based on the returned image, thereby determining whether the liquid crystal mixture in the mixers 150A and 150B can be well-stratified into the liquid crystal and the solvent. Specifically, the controller 260 may determine whether the liquid crystal mixture is well-stratified in the image observation box 240 within a certain period of time. Compared to the liquid crystal mixture in the mixers 150A and 150B, the amount of the liquid crystal mixture in the image observation box 240 is less, so it can be used to determine whether the liquid crystal mixture is well-stratified in the mixers 150A and 150B within a short time. If the liquid crystal mixture in the image observation box 240 is well-stratified, it is determined that the liquid crystal mixture in the mixers 150A and 150B is also well-stratified. If the liquid crystal mixture in the image observation box 240 is not well-stratified, it is determined that the liquid crystal mixture in the mixers 150A and 150B cannot be well-stratified. In some embodiments, the controller 260 may determine whether the liquid crystal mixture is well-stratified by analyzing the change in the contrast of each area of the image returned by the image observation box 240. For example, when the liquid crystal mixture is well-stratified into the liquid crystal and the solvent, an obvious boundary is between the liquid crystal and the solvent, and there is a significant contrast changes in the areas near the boundary. These contrast changes may be detected by the controller 260 and the separation condition of the liquid crystal mixture is determined. Since the solvent in some embodiments of the present disclosure are reusable to separate different batches of the glass-liquid crystal mixture, when the liquid crystal mixture cannot be well-stratified, it means that the solvent contains too much impurity (such as liquid crystal). The solvent is not able to separate the liquid crystal from the glass-liquid crystal mixture effectively.

The controller 260 may control the electric control valves 250 based on the separation condition of the liquid crystal mixture to decide the liquid crystal mixture flows to the settling tank 220 or the liquid crystal storage tank 230. For example, if the controller 260 determines that the liquid crystal mixture in the image observation box 240 may be well-stratified, the controller 260 may open the electric control valves 250E, 250F (or 250G) and 250H and close the electric control valves 2501 and 250J, so that the liquid crystal mixture in the image observation box 240 and the mixers 150A (or 150B) flows along pipelines L8 (or L9), L10 and L11 to the settling tank 220, and will not flow out of the settling tank 220 to perform steps S136 and S137 subsequently. If the controller 260 determines that the liquid crystal mixture in the image observation box 240 cannot be well-stratified, the controller 260 opens the electric control valves 250E, 250F (or 250G), 250H and 250J and closes the electric control valves 2501 to perform steps S138 and S139 subsequently.

In some embodiments, controller 260 further controls switches of the pumps 270 based on the separation condition of the liquid crystal mixture. If the controller 260 determines that the liquid crystal mixture in the image observation box 240 may be well-stratified, the controller 260 turns on the pumps 270B and 270C in addition to opening the electric control valves 250E, 250F (or 250G) and 250H. If the controller 260 determines that the liquid crystal mixture in the image observation box 240 cannot be well-stratified, the controller 260 turns on the pumps 270B, 270C and 270F in addition to opening the electric control valves 250E, 250F (or 250G), 250H and 250J.

When the controller 260 determines that the liquid crystal mixture in the image observation box 240 may be well-stratified, in step S136, the liquid crystal mixture is transported to the settling tank 220 and is separated in the settling tank 220. Specifically, the liquid crystal and the solvent in the liquid crystal mixture have significant difference in specific gravity. Therefore, settling time of the liquid crystal mixture in the settling tank 220 may be set. After the settling time, the liquid crystal and the solvent in the liquid crystal mixture are stratified by the difference in specific gravity. For example, the specific gravity of the liquid crystal is greater than the specific gravity of the solvent, so the liquid crystal is below the solvent after the settling time. In step S137, the glass sand is transported to the glass storage area 290. Steps S137 and S136 may be performed at the same time. That is, after transporting the liquid crystal mixture to the settling tank 220, the glass sand remaining in the mixers 150A and 150B may be transported to the glass storage area 290. Meanwhile, the liquid crystal mixture may be settled and separated in the settling tank 220. The glass sand stored at the glass storage area 290 does not contain liquid crystal, and is available for further utilization.

When the controller 260 determines that the liquid crystal mixture in the image observation box 240 cannot be well-stratified, in step S138, the liquid crystal mixture is transported along the pipelines L8 (or L9), L10, L11 and L12 to the liquid crystal storage tank 230, and in step S139, the glass sand is transport to the glass storage area 290 along the material flow M4 and M5. For convenient operation, step S138 may be performed first, and then step S139 is performed. That is, after transporting the liquid crystal mixture in the mixer 150A or 150B to the liquid crystal storage tank 230, the glass sand is transported to the glass storage area 290. The glass sand stored at the glass storage area 290 does not contain liquid crystal, and is available for further utilization.

After step S135 is finished, step S140 is subsequently performed, and it is determined whether a part of the solvent should be renewed based on the tested chemical properties. Specifically, it is determined whether a portion of the solvent should be renewed based on the chemical properties tested in step S133. If the chemical properties of the solvent do not meet the standard described in step S134, step S141 is performed to renew a part of the solvent. Specifically, a part of the solvent is removed along the pipeline L12, and new solvent is added from the pipeline L13 to maintain the chemical properties of the solvent in an acceptable range. Subsequently, step S142 is performed. If the chemical properties of the solvent meet the standard described in step S134, go directly to step S142.

Subsequently, step S142 is performed to observe the image of the liquid crystal mixture in the settling tank 220. In some embodiments, the settling tank 220 includes an image observation box equipped with a camera, and the image observation box is configured to observe the separation condition of the liquid crystal mixture. The separation condition of the liquid crystal mixture is captured as image and is returned to the controller 260. The controller 260 may determine whether the liquid crystal mixture is well-stratified in the settling tank 220 based on the returned image, thereby determining whether the liquid crystal mixture in the settling tank 220 can be well-stratified into the liquid crystal and the solvent. The details of determining the separation condition of the liquid crystal mixture in the settling tank 220 by the controller 260 is similar to the description in step S133, and are not described herein repeatedly.

Subsequently, in step S143, a flow direction of the liquid crystal mixture is controlled by the electric control valves 250 based on the separation condition of the liquid crystal mixture. Specifically, the controller 260 may determine whether the liquid crystal mixture is well-stratified in the settling tank 220 based on the returned image, thereby determining whether the liquid crystal mixture in the settling tank 220 can be well-stratified into the liquid crystal and the solvent. In some embodiments, the controller 260 may determine whether the liquid crystal mixture is well-stratified by analyzing the change in the contrast of each area of the image returned by the settling tank 220. For example, when the liquid crystal mixture is well-stratified into the liquid crystal and the solvent, an obvious boundary is between the liquid crystal and the solvent, and there is a significant contrast changes in the areas near the boundary. These contrast changes may be detected by the controller 260 and the separation condition of the liquid crystal mixture is determined.

The controller 260 may control the electric control valves 250 based on the separation condition of the liquid crystal mixture to decide whether the liquid crystal mixture flows to the liquid crystal storage tank 230. For example, if the controller 260 determines that the liquid crystal mixture in the settling tank 220 may be well-stratified, the controller 260 may open the electric control valves 2501 and 250K and close the electric control valve 250J, and go to next steps S144 and S145. If the controller 260 determines that the liquid crystal mixture in the settling tank 220 cannot be well-stratified, the controller 260 opens the electric control valve 250J and closes the electric control valves 2501 to perform step S146 subsequently. The liquid crystal mixture is then transported to the liquid crystal storage tank 230.

In some embodiments, controller 260 further controls switches of the pumps 270 based on the separation condition of the liquid crystal mixture. If the controller 260 determines that the liquid crystal mixture in the settling tank 220 may be well-stratified, the controller 260 turns on the pumps 270D and 270E in addition to opening the electric control valves 2501 and 250K. If the controller 260 determines that the liquid crystal mixture in the settling tank 220 cannot be well-stratified, the controller 260 turns on the pumps 270F in addition to opening the electric control valves 250J.

If the controller 260 determines that the liquid crystal mixture in the settling tank 220 may be well-stratified into the solvent and the liquid crystal, step S144 is performed to transport the solvent back to the mixers 150A and 150B along pipelines L14 and L15 (or L16), and then step S132 is repeated to mix the solvent and the glass-liquid crystal mixture by the mixers 150A and 150B. Specifically, the mixers 150A and 150B contains a new batch of the glass-liquid crystal mixture, and the reused solvent is added to the mixers 150A and 150B again for separating the new batch of the glass-liquid crystal mixture. As such, the solvent is reusable to separate different batches of the glass-liquid crystal mixture, thereby saving the amount of the used solvent and reducing the cost. In some embodiments, the same solvent may separate 8-10 batches of the glass-liquid crystal mixture repeatedly. During or after step S144, step S145 is performed to transport the liquid crystal mixture to the liquid crystal storage tank 230.

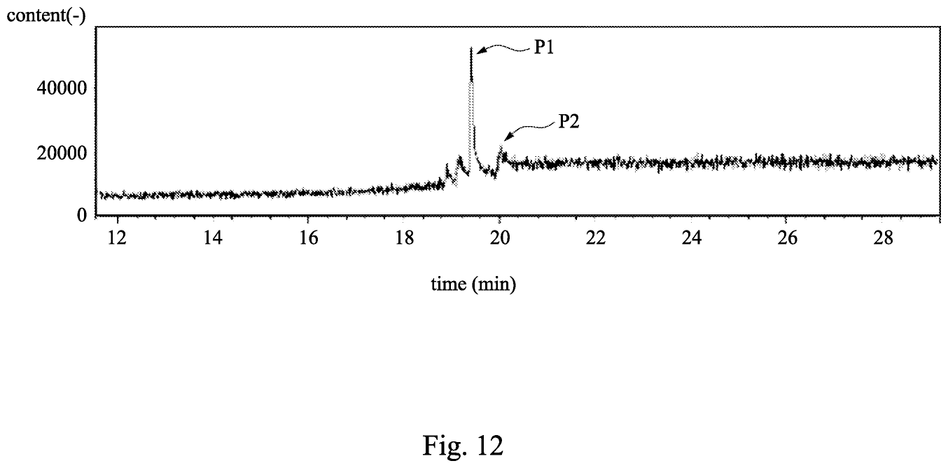

In some embodiments, appropriate testing may be performed on the collected liquid crystal, glass sand and optical film debris. Specifically, the liquid crystal and the liquid crystal mixture (including liquid crystal and solvent) collected in step S137, S142, S143, and S144 may be tested by gas chromatography (GC) to ensure that the discharged liquid crystal mixture include liquid crystal. For example, FIG. 12 illustrates a GC spectrum of the liquid crystal mixture in some embodiments. According to FIG. 12, under certain column condition, the spectrum shows two peaks P1 and P2 representing the liquid crystal between 18^{th} and 22^{nd} minutes. That is, it is ensured that the discharged liquid crystal mixture includes liquid crystal according to FIG. 12.

Before utilizing the glass sand collected in steps S136 and S138 and the optical film debris collected in steps S112, S114 and S115, physical properties and chemical properties of the glass sand collected in steps S136 and S138 and the optical film debris collected in steps S112, S114 and S115 may be tested to determine whether the quality of the recycled glass sand and the optical film debris may be available for reutilization. In some embodiments, the testing of the glass sand and the optical film debris may relate to iodine content, toxicity characteristic leaching procedure, metal content, proximate analysis (moisture, ash and flammable fraction) and sulfur/chloride content, and the glass sand and the optical film debris may be applicable in different fields based on different physical properties and chemical properties. Since iodine is one of the main substances of the optical film debris, the iodine content of the glass sand may also be used as the basis for determining the degree of film removal efficiency. After finishing the testing above, the collected glass sand and the optical film debris may be reutilized. For example, glass sand can be used to form glass raw materials, glass handicrafts, road/civil engineering/construction ingredients, industrial materials, or the like. The optical film debris may be used to form active carbon or the like.

As mentioned above, the waste liquid-crystalline glass is separated into the optical film debris, the liquid crystal and the sand glass effectively. Specifically, different film removal operations are performed in the liquid-crystalline glass film removing module in the waste liquid-crystalline glass recycling system of the present disclosure to completely separate the optical film debris. The operation of using the solvent to separate the liquid crystal and the glass is performed in the liquid-crystalline glass separation module of the present disclosure. The used solvent is reusable to reduce the amount of the used solvent. Moreover, it may be automatically determined whether the solvent is reusable based on the equipment such as controller and observation box in the liquid-crystalline glass separation module to reduce the labor cost of the process.

Although the present invention has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A waste liquid-crystalline glass recycling system, comprising:
a liquid-crystalline glass film removing module, comprising
a crushing device, configured to crush a liquid crystal panel;
a film removal device connected with the crushing device, and configured to separate the liquid crystal panel into a glass-liquid crystal mixture and optical film debris; and
a liquid-crystalline glass separation module connected with the liquid-crystalline glass film removing module, and configured to separate the glass-liquid crystal mixture into glass sand and a liquid crystal mixture by using a solvent, wherein the liquid crystal mixture includes the solvent.

2. The waste liquid-crystalline glass recycling system of claim 1, wherein the crushing device comprises:
a primary crusher configured to crush the liquid crystal panel into coarse particles of liquid crystal panel debris;
a fine crusher connected with the primary crusher, and configured to crush the coarse particles of the liquid crystal panel debris and form fine particles of the liquid crystal panel debris, wherein diameters of the fine particles of the liquid crystal panel debris are smaller than diameters of the coarse particles of the liquid crystal panel debris; and
a vibrating screener connected with the fine crusher, and configured to separate the optical film debris from the fine particles of the liquid crystal panel debris.

3. The waste liquid-crystalline glass recycling system of claim 2, wherein the film removal device is connected with the primary crusher, and is configured to remove first film debris of the optical film debris from the coarse particles of the liquid crystal panel debris.

4. The waste liquid-crystalline glass recycling system of claim 2, wherein the film removal device is connected with the fine crusher, and is configured to remove second film debris of the optical film debris from the fine particles of the liquid crystal panel debris.

5. The waste liquid-crystalline glass recycling system of claim 2, wherein the film removal device is connected with the vibrating screener, and is configured to remove third film debris of the optical film debris from the vibrating screener.

6. The waste liquid-crystalline glass recycling system of claim 2, wherein the vibrating screener is connected with a mixer, and the mixer is configured to perform a wet film removal process to remove fourth film debris of the optical film debris on the fine particles of the liquid crystal panel debris, and the fine particles of the liquid crystal panel debris after performing the wet film removal process is the glass-liquid crystal mixture.

7. The waste liquid-crystalline glass recycling system of claim 1, wherein the liquid-crystalline glass separation module comprises:
a liquid storage tank configured to store the solvent; and
a mixer connected with the liquid storage tank, and is configured to mix the solvent and the glass-liquid crystal mixture, so that the solvent separates the glass-liquid crystal mixture into the glass sand and the liquid crystal mixture.

8. The waste liquid-crystalline glass recycling system of claim 7, wherein the liquid-crystalline glass separation module further comprises:
a sensor connected with the mixer, and is configured to test a chemical property of the solvent; and
a controller connected with the sensor, and is configured to receive a value of the chemical property of the solvent, a warning message is shown when the value of the chemical property is beyond a predetermined value.

9. The waste liquid-crystalline glass recycling system of claim 7, wherein the liquid-crystalline glass separation module further comprises:
an image observation box configured to observe a separation condition of the liquid crystal mixture from the mixer.

10. The waste liquid-crystalline glass recycling system of claim 9, wherein the liquid-crystalline glass separation module further comprises:
a plurality of electric control valves configured to control a flow direction of the liquid crystal mixture and the solvent; and
a controller communicatively connected to the image observation box, and configured to control the electric control valves based on an image provided by the image observation box.

11. The waste liquid-crystalline glass recycling system of claim 1, further comprising:
an optical film treatment module connected with the liquid-crystalline glass film removing module, and configured to calcine the optical film debris.

12. A method of recycling liquid-crystalline glass, comprising:
crushing a liquid-crystalline glass into a crushed mixture comprising optical film debris and a glass-liquid crystal mixture;
removing the optical film debris from the crushed mixture; and
after removing the optical film debris, separating the glass-liquid crystal mixture into glass sand and a liquid crystal mixture by using a solvent, wherein the liquid crystal mixture comprises the solvent.

13. The method of claim 12, wherein separating the glass-liquid crystal mixture into the glass sand and the liquid crystal mixture by using the solvent comprising:
mixing the solvent and the glass-liquid crystal mixture by a mixer;
observing the glass-liquid crystal mixture from the mixer; and
controlling a flow direction of the liquid crystal mixture by a plurality of electric control valves based on a separation condition of the liquid crystal mixture.

14. The method of claim 13, further comprising:
testing chemical properties of the solvent in the mixer; and
determining whether the solvent should be renewed based on the chemical properties of the solvent.

15. The method of claim 13, wherein observing the glass-liquid crystal mixture from the mixer comprises:
transporting the liquid crystal mixture to a settling tank;
separating the liquid crystal mixture in the settling tank;
capturing the separation condition of the liquid crystal mixture as an image; and
returning the image to a controller.

16. The method of claim 15, further comprising determining whether the liquid crystal mixture in the mixer is well-stratified into a liquid crystal and the solvent by the controller based on the image returned to the controller before controlling the flow direction of the liquid crystal mixture by the electric control valves based on the separation condition of the liquid crystal mixture.

17. The method of claim 12, wherein the solvent is a mixture of sweet orange oil and polyethylene glycol, and total organic carbon of the solvent is between 24000 ppm to 100000 ppm.

18. The method of claim 12, further comprising:
calcining the optical film debris to form active carbon after removing the optical film debris.

19. The method of claim 12, wherein crushing the liquid-crystalline glass into a crushed mixture comprises:
performing a primary crushing process of the waste liquid-crystalline glass to form coarse particles of the liquid-crystalline glass; and
crushing the coarse particles of the liquid-crystalline glass to form fine particles of liquid-crystalline glass.

20. The method of claim 19, wherein removing the optical film debris from the crushed mixture comprises:
removing first film debris of the optical film debris from the coarse particles of the liquid-crystalline glass;
removing second film debris of the optical film debris from the fine particles of the liquid-crystalline glass;
transporting the fine particles of the liquid-crystalline glass to a vibrating screener;
separating the optical film debris from the fine particles of the liquid-crystalline glass to remove third film debris of the optical film debris from the vibrating screener; and
performing a wet film removal process to remove fourth film debris of the optical film debris on the fine particles of the liquid-crystalline glass.
